(19) United States
(12) Patent Application Publication
(10) Pub. No.: US 2009/0052157 A1
(43) Pub. Date: Feb. 26, 2009

(54) LIGHT EMITTING DEVICE AND LIGHTING APPARATUS

(75) Inventor: Kousuke Katabe, Higashiomi (JP)

Correspondence Address: DITTHAVONG MORI & STEINER, P.C., 918 Prince St., Alexandria, VA, 22314, US

(73) Assignee: Kyocera Corporation, Kyoto (JP)

(21) Appl. No.: 11/817,013

(22) PCT Filed: Feb. 24, 2006
(86) PCT No.: PCT/JP2006/303409

§ 371 Date: Aug. 23, 2007

(30) Foreign Application Priority Data
Feb. 24, 2005 (JP) 2005-049811

(51) Int. Cl. C09K 11/00

(52) U.S. Cl. 362/84

(57) ABSTRACT

A light emitting device having a high light emitting efficiency is provided. The light emitting device is provided with a light-emitting chip 4 which emits a first light having a peak wavelength within a first wavelength range; a fluorescent layer 6, which is arranged above the light-emitting chip 4 and emits a second light having a peak wavelength within a second wavelength range which is larger than the first wavelength range, corresponding to the first light; and a reflecting surface which surrounds a region between the light-emitting chip 4 and the fluorescent layer 6 and scatters and reflects the first light emitted from the light-emitting chip 4 and the first light reflected by the fluorescent layer 6.

### TECHNICAL FIELD

The present invention relates to a light emitting diode device, especially a light emitting device which converts the wavelength of the light from the light-emitting chip and emits a light with a converted wavelength to the outside and a lighting apparatus using the device.

### BACKGROUND ART

Conventional light emitting device is mainly composed of a base and a reflecting member, wherein the base is made of an insulating material, and places a light-emitting chip at the center part of the top surface, and the insulating material is provided with a lead terminal electrically connecting the inside and the outside of the light-emitting chip and a package for receiving the light-emitting chip (hereinafter, referred as “the package”) or a wiring conductor (not shown) comprising a metalized wiring layer, and the reflecting member is adhered and fixed on the top surface of the base and is composed of metal, resin or ceramics, having a through hole for receiving the light-emitting chip.

Also, the wiring conductor formed on the surface of the base is electrically connected with an electrode of the light-emitting chip through a bonding wire, and then, a translucent resin fills the inside of the reflecting member to be thermosetted, where a fluorescent layer containing fluorescent materials is formed on the translucent resin. If necessary, a light transmitting cover is connected onto the top surface of the reflecting member by solder or resin adhesives and so on, whereby the wavelength of the light emitted from the light-emitting chip is converted by the fluorescent layer, and a light emitting device which can extract the light with the desired wavelength spectrum can be obtained.

Further, the color tone can be designed freely by selecting the light-emitting chip of which the wavelength includes the ultraviolet region of 300 to 400 nm, and adjusting the mixture ratio of the fluorescent particles, which emits the lights with the colors of red, blue and green, in the fluorescent layer.

However, among the above light emitting devices, low light emitting efficiency of the light emitting device seems to be a problem that occurs in the device which converts the light into visual light by the fluorescent materials included in the fluorescent layer, when the light-emitting chip of which the wavelength includes the ultraviolet regions of 350 to 410 nm is chosen. This is because the ability of the fluorescent materials capable of converting a wavelength of light emitted from the light-emitting chip, that is, the wavelength conversion efficiency is low. Accordingly, the light emitting efficiency of the light emitting device can be improved by increasing the wavelength conversion efficiency, however, the fluorescent material which is currently used, is developed for a fluorescent lamp, and most of the materials have an excited wavelength of 300 nm or less and the materials are designed to convert the wavelength with high efficiency.

Generally, the wavelength conversion efficiency in the fluorescent materials is represented by the value of an absorption ratio multiplied by an internal quantum efficiency, wherein the absorption ratio represents how much of the light emitted from the light-emitting chip is absorbed into the fluorescent materials, and the internal quantum efficiency represents how much of the wavelength of the absorbed light is converted.

In order to investigate which of the absorption ratio or the internal quantum efficiency affects the wavelength conversion efficiency, a total reflectance of the fluorescent layer is investigated and in order to estimate a ratio of how much light the fluorescent layer reflects in a wavelength range of the light emitted from the light-emitting chip, the total reflectance of the fluorescent layer is measured. Also, a spectrophotometer of a CM-3700D™ manufactured by Konica Minolta, Japan is used to measure the total reflectance. The total reflectance of the fluorescent layer shows a dependency on wavelength as described in FIG. 2.

Referring to FIG. 2, it is understood that about 30% of the light emitted from the light-emitting chip is reflected since the light emitted from the light-emitting chip has the wavelength of about 350 to 410 nm. Therefore, it can be inferred that the fluorescent layer absorbs only about 70% of the light emitted from the light-emitting chip. Since, the absorption ratio of the fluorescent materials in the fluorescent layer is low and the wavelength conversion efficiency is low, it is conjectured the efficiency of the light emitting device is deteriorated.

In the conventional light emitting device, all of the light emitted from the light-emitting chip does not excite the fluorescent materials in the fluorescent layer, and some of the light is reflected from the fluorescent materials and returned to the downside. And the returned light is absorbed into the light-emitting chip, the wiring conductor, the base and the contact portion between each member, thereby resulting in the low light emitting efficiency in the light emitting device.

The present invention has been devised in consideration of the above-described problems in the related art, and accordingly the object of the present invention is to provide a light emitting device and a lighting apparatus using the same, which has a high light emitting efficiency by increasing the probability that the light emitted from the light-emitting chip excites a fluorescent particle.

The present invention provides a light emitting device comprising: a light-emitting chip which emits a first light having a peak wavelength within a first wavelength range; a fluorescent layer which is arranged above the light-emitting chip and emits a second light having a peak wavelength within a second wavelength range which is larger than the first wavelength range corresponding to the first light; and a reflecting surface which surrounds the region between the light-emitting chip and the fluorescent layer and scatters and reflects the first light emitted from the light-emitting chip and the first light reflected by the fluorescent layer.

Further objects, features, and advantages according to the present invention will be more explicit from the following detailed descriptions and the drawings.

### BRIEF DESCRIPTION OF THE DRAWINGS

FIG. 1 is a sectional view showing an example of a light emitting device in accordance with one of the embodiments of the present invention.

FIG. 2 is a graph showing the characteristics of wavelength with respect to reflectance of the fluorescent layer used in the conventional light emitting devices.

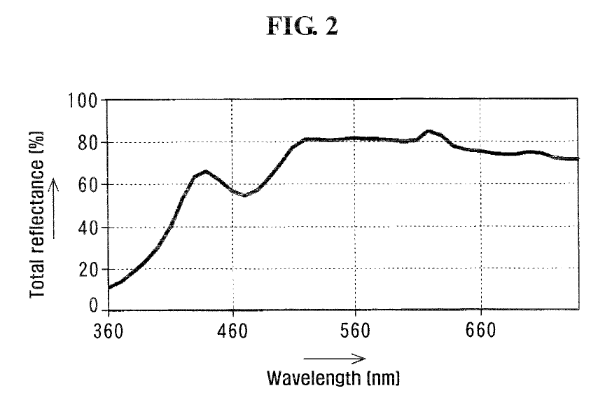

FIG. 3 is a sectional view showing a reflecting member used in the light emitting device in the embodiment of the present invention.

FIG. 4 a graph showing the characteristics of wavelength with respect to reflectance of the light emitting device used in light emitting device in the embodiment of the present invention.

### BEST MODE FOR CARRYING OUT THE INVENTION

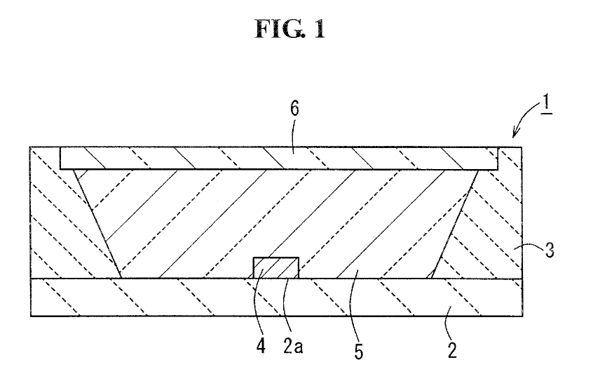

Now, a detailed description of a light emitting device according to the present invention will be given below. FIG. 1 is a sectional view showing the light emitting device in accordance with one of the embodiments of the present invention. Reference numeral 2 denotes a base, 3 denotes a reflecting member, 4 denotes a light-emitting chip which emits a first light having a peak wavelength within the first wavelength range, 5 denotes a light transmitting member such as translucent resin or glass etc, 6 denotes a fluorescent layer which is comprised of a fluorescent material and emits a second light having a peak wavelength within the second wavelength range which is larger than the first wavelength range, corresponding to the first light.

The light emitting device according to the present invention comprises a base 2; a reflecting member 3; a light-emitting chip which emits a first light having a peak wavelength within the first wavelength range 4; a light transmitting member such as translucent resin or glass etc 5; a fluorescent layer which is comprised of the fluorescent materials and emits a second light having a peak wavelength within the second wavelength range which is larger than the first wavelength range, corresponding to the first light 6. The base 2 has, on its top surface, a mounted portion for placing the light-emitting chip. The reflecting member 3 has a frame-like form and is disposed on a periphery of the upper surface of the base 2 and also has an inner surface of which is formed as a light reflection surface. The wiring conductor has one edge disposed on the top surface of the base 2 and electrically connected to the electrode of the light-emitting chip 4, and has the other edge extracted to the outer surface of the base. The light-emitting chip 4 is mounted on the mounted portion 2a and electrically connected to the wiring conductor.

The light emitting device according to the present invention is formed such that the opening part of the reflecting member 3 is filled with fluorescent layer 6 including fluorescent materials comprised in the upper part of the light-emitting chip 4, and has a diffusive reflecting surface as the inner main surface of the reflecting member 3, and the fluorescent layer 6 is composed of fluorescent materials contained in the translucent member, and the light emitted from the light-emitting chip 4 is wavelength conversed by the fluorescent materials.

By this structure, the light emitted from the light-emitting chip 4 is returned to the downside by being reflected on the surface of the fluorescent material without exciting the fluorescent material, and then the light is proceeded to an upper side again by scattered reflection on the diffusive reflecting surface of the inner main surface of the reflecting member 3, thereby the light is absorbed in the fluorescent materials in the fluorescent layer 6 effectively. As a result, the light emitting device 1 with a high light emitting efficiency can be obtained by improving the wavelength conversion efficiency of fluorescent material.

Further, the required time during which the light emitted from the light-emitting chip 4 is reflected by the fluorescent layer 6, returned effectively to the upper side from the diffusive reflecting surface, and collides with the fluorescent layer 6 again, in the closed space determined by the reflecting member 3, the fluorescent layer 6, and the base 2, can be made much shorter than the light emitting lifetime of the fluorescent material. And since, the amount of activating agent contained in fluorescent material is sufficiently larger than that of the photon emitted from the light-emitting chip 4, the light emitted from the light-emitting chip 4 can be effectively absorbed in the fluorescent material in the fluorescent layer 6, by multiply reflecting the light emitted from the light-emitting chip 4 in the closed space determined by the reflecting member 3, the fluorescent layer 6, and the base 2 and colliding multiple times with the fluorescent layer 6.

Further, a conventional light emitting device uniforms the compound color of the light from the light-emitting chip and the light emitted from the fluorescent materials by lessening the difference in an optical path length of the light emitted from the light-emitting chip. And inferring from the effect, the second coating containing the fluorescent materials is required to transmit a major amount of light from the light-emitting chip. Since it is easy to break the balance between a direct light from the light-emitting chip and a light converted in the wavelength, it is difficult to obtain a preferable wavelength spectrum depending on environmental changes such as temperature change. Compared to the above, the light emitting device according to the present invention enhances the wavelength conversion efficiency of fluorescent materials by colliding multiple times the light from the light-emitting chip 4 with the fluorescent layer 6 in a closed space determined by the reflecting member 3 and the fluorescent layer 6. And, the light emitting device according to the present invention obtains a light with the desired wavelength through wavelength by converting most of the light from the light-emitting chip 4 in wavelength, and effectively obtains a preferable wavelength spectrum despite environmental changes such as temperature change, because a wavelength converted light is used and most of the direct light from the light-emitting chip is barely used.

Also, the diffusive reflecting surface according to the present invention means that, when the light is entered onto the main surface at a certain incidence angle, the ratio (P)(P=i/I) of the intensity (i) of specularly reflected light (specularly reflected light reflected in the angle of reflection (θ)) to the intensity (I) of the whole reflection light reflected in every direction on the main surface (the total intensity of the light reflected in every direction) is 50% or less.

The base 2 according to the present invention is a supporting member to support the light-emitting chip 4, and is formed of ceramics such as sintered aluminium oxide (alumina ceramics), sintered aluminium nitride, sintered mullite or glass ceramics, or a glass insulator such as silica. Further the base 2 functions as the light reflecting surface by endowing the exposure surface of the base 2 with the light reflecting property.

Moreover, a wiring conductor (not shown), which is made, for example, by metallizing with the metal power such as W, Mo or Mn, is formed on the surface or in the interior of the base 2 for conductively connecting the inside and the outside of the light emitting device 1 electrically. Further, an electrode (not shown), which is made of a part of the wiring conductor, is formed on the central part of the upper surface of the base 2 for placing the light-emitting chip 4. Further, a lead terminal made of metal such as Cu, Fe—Ni alloy is joined with the wiring conductor extracted to the outside surface, such as the lower surface of the base 2. And then the light-emitting chip 4 is joined with the electrode for placing the light-emitting chip 4 by conductive joining materials (not shown) such as Au—Sn eutectic solder. Hereupon, the lead terminal is electrically connected with an exterior electric circuit, and therefore the exterior electric circuit and the light-emitting chip 4 are electrically connected.

It is preferable when the electrode has its exposed surface coated with a highly corrosion-resistant metal such as Ni and gold (Au) in the thickness ranging from 1 to 20 μm. This makes it possible to protect the electrode against oxidative corrosion effectively, and also to strengthen the electrical connection between the electrode and the light-emitting element 4, as well as the connection between the electrode and the conductive joining materials. Accordingly, the exposed surface of the electrode preferably is coated with a Ni plating layer having the thickness of 1˜10 μm and a Au plating layer having the thickness of 0.13 μm sequentially by the electrolytic plating method or the electroless plating method.

The light emitting device according to the present invention surrounds the region between the light-emitting chip 1 and the fluorescent layer 6, and has a reflecting surface that scatters the first light emitted from the light-emitting chip 4 and the first light reflected by the fluorescent layer 6.

It is preferable when the upper surface of the base 2 except the mounted portion 2a of the light-emitting chip 4 in the light emitting device is formed as a diffusive reflecting surface. This diffusive reflecting surface can be formed by coating ceramic particles, such as alumina, zirconia or titania, on the surface of the base 2. Because the diffusive reflecting surface originates in the whole reflection that occurs in the surface of the ceramic particles, when the ceramic particles are bigger than ¼ of a wavelength of the light emitted from the light emitting device 4 and the fluorescent layer which contains fluorescent materials, particles with smaller diameter, and with amorphous shape such as a cylinder shape or plate shape are able to totally reflect the light preferably.

Also, it is preferable that the refractive index of the ceramic particle is as high as possible because the diffusive reflecting surface originates in the whole reflection that occurs in the surface of the ceramic particles. That is, because the diffusive reflectance increases when the angle area that can totally reflect the light entering into the ceramic particles is bigger.

Further, in case the light-emitting chip 4 emits the light near the ultraviolet with the wavelength of 380˜410 nm, it is preferable to use alumina or zirconia as the ceramic particles, because titania has the light absorbing property by the bandgap near the wavelength of 350˜380 nm, and therefore the upper limit of the light absorbing property of titania overlaps the lower limit of the light absorbing property of the light-emitting chip 4 emitting light near ultraviolet, and absorbs optical output of the light-emitting chip 4.

Moreover it is preferable that the ceramic particles are mixed with a resin or a low-melting point glass or a sol-gel glass to connect themselves, because the particles have low adhesion strength when it is coated in the particle states. When choosing resin or low melting glass, sol-gel glass, and so on, a material that does not absorb the light emitted from the light-emitting chip 4 or the fluorescent layer 6 containing a fluorescent materials, should be selected. For example, in case the light-emitting chip 4 emits the light near the ultraviolet with the wavelength of 380˜410 nm and the fluorescent layer 6 containing fluorescent materials emits light with the wavelength of 380˜780 nm, resin or low melting glass, or sol-gel glass should be selected as the one that does not absorb the near ultraviolet light with the wavelength of 380˜410 nm and the light with the wavelength of 380˜780 nm of the light-emitting chip 4.

For example, in case the ceramic particle is an alumina with the center particle diameter of 0.5˜1 μm and silicon resin is selected to connect the ceramic particles, a diffusive reflecting surface with a good reflectance can be obtained by coating the mixture of 0.1 parts by weight of silicon resin and 1 part by weight of alumina on the surface of the base 2 to have the thickness of about 200 μm.

Further, the diffusive reflecting surface can be obtained by forming the base 2 with the materials for example, fillers such as ceramics added to resin (for example, AMODELTM of AS-1566 HS manufactured by Solvay Advanced Polymer or Xydar™ white color grade manufactured by Shin Nippon Sekiyu Kagaku) or press molded resin particles, or by coating on the surface of the base 2 with the materials.

It is preferable that the base 2 is made of the materials which the total reflectance of the exposed surface in the main surface where the light-emitting chip is mounted, is 90% or more in the visible wavelength region. As a result the base 2 absorbs less light emitted from the light-emitting chip 4. Consequently, the light emitting device with a high light emitting efficiency can be obtained because more light is absorbed into the fluorescent layer 6.

The reflecting member 3 is a circular with a through hole and is attached on the top surface of the base 2 so that the light-emitting chip 4 is mounted in the center of the through hole, by using an inorganic adhesive such as solder, sol-gel glass, or low melting-point glass, or an organic adhesive such as epoxy resin. Note that the inorganic adhesive is more preferable in terms of durability.

The inner main surface of the reflecting member 3 according to the present invention is a diffusive reflecting surface. The inner main surface can be a diffusive reflecting surface by coating the surface of reflecting member 3 with ceramic particles using inorganic particles such as alumina, zirconia or titania.

Because the diffusive reflecting surface originates in the whole reflection that occur in the surface of the ceramic particles, if the ceramic particles are bigger than ¼ of the wavelength of the light emitted from the light emitting device 4 and the fluorescent layer containing fluorescent materials, ceramic particles with smaller particle diameter, and with amorphous shape such as a cylinder shape or plate shape is preferable for a satisfactory total reflectance.

Also, it is preferable that the refractive index of the ceramic particles is as high as possible because the diffusive reflecting surface originates in the whole reflection that occurs in the surface of the ceramic particles. That is, because the diffusive reflectance increases when the angle area that can totally reflect the light entering into the ceramic particles, are bigger.

Further, in case the light-emitting chip 4 emits the light near the ultraviolet with the wavelength of 380˜410 nm, it is preferable to use alumina or zirconia as the ceramic particles, because titania has the light absorbing property by the band gap near the wavelength of 350˜380 nm, and therefore the upper limit of the light absorbing property of titania overlaps the lower limit of the light absorbing property of the light-emitting chip 4 emitting near ultraviolet, and absorbs optical output of the light-emitting chip 4 with the overlapping wavelength.

Moreover it is preferable that the ceramic particles are mixed with a resin or a low-melting point glass or sol-gel glass to connect themselves, because the particles have low adhesion strength when it is coated in the particle states. When choosing resin or low melting glass, sol-gel glass, and so on, a material that does not absorb the light emitted from the light-emitting chip 4 or the fluorescent layer 6 containing a fluorescent material, should be selected. For example, in case the light-emitting chip 4 emits the light near the ultraviolet with the wavelength of 380˜410 nm and the fluorescent layer 6 containing fluorescent materials emits light with the wavelength of 380˜780 nm, resin or low melting glass, sol-gel glass should be selected as the one that does not absorb the near ultraviolet light with the wavelength of 380˜410 nm and the light with the wavelength of 380˜780 nm of the light-emitting chip 4.

For example, in case the ceramic particle is an alumina with the center particle diameter of 0.5˜1 μm and silicon resin is selected to connect the ceramic particles, a diffusive reflecting surface with a good reflectance can be obtained by coating the mixture of 0.1 parts by weight of silicon resin and 1 part by weight of alumina on the surface of the base 2 to have thickness of about 200 μm.

Further, the diffusive reflecting surface can be obtained by forming the base 2 with the materials for example, fillers such as ceramics added to resin (for example, AMODELTM of AS-1566 HS manufactured by Solvay Advanced Polymer or Xydar™ white color grade manufactured by Shin Nippon Sekiyu Kagaku) or press molded resin particles, or by coating on the surface of the base 2 with the materials.

Particularly it is preferable that the material of the inner main surface in the reflecting member 3 has the total reflectance of 90% or more in visible wavelength region. Therefore, damping of the light emitted from light-emitting chip 4 can be reduced, when the light is locked in a closed space composed of the fluorescent layer 6, the reflecting member 3 and the base 2. As a result more light can be absorbed in the fluorescent layer, and the light emitting device with high light emitting efficiency can be obtained.

Further, it is preferable that the quantity of light that is released to the outside of the fluorescent layer 6 without wavelength conversion among the light emitted from the light-emitting chip 4 is 20% or less of the quantity of light emitted from the light-emitting chip 4. As a result lights emitted from the light-emitting chip and released to the outside of the fluorescent layer 6 without wavelength conversion is effectively reduced. Therefore, the probability to convert the light into the desired light by multiply reflecting it within the light emitting device 1 can be increased. Consequently, it becomes the light emitting device 1 that has the high intensity of the desired light.

When the quantity of light that is released to the outside of the fluorescent layer 6 without wavelength conversion among the light emitted from the light-emitting chip 4 is more than 20% of the quantity of light emitted from the light-emitting chip 4, most of the light emitted from the light-emitting chip 4 is released without wavelength conversion in the fluorescent layer 6. Consequently it is difficult for the light emitted from the light-emitting chip 4 to be absorbed effectively in the fluorescent materials of fluorescent layer 6 by multiply reflecting the light emitted from the light-emitting chip 4 in the closed space determined by the fluorescent layer 6, the reflecting member 3 and the base 2 and colliding with the fluorescent layer 6 multiple times. Therefore it is difficult to promote the wavelength conversion efficiency of the fluorescent materials. More preferably, the quantity of light that is released to the outside of the fluorescent layer 6 without wavelength conversion among the light emitted from the light-emitting chip 4, is less than 5% of the quantity of light emitted from the light-emitting chip 4.

Moreover it is preferable that a light transmitting member 5 is formed in the light emitting device according to the present invention to cover the light-emitting chip 4. That is, light transmitting resin fills the inner space of the reflecting member 3 that is determined by the reflecting surface surrounding the light-emitting chip 4. As a result, the loss that occurs when the light of the light-emitting chip is advanced to a peripheral part can be reduced by lessening the difference of the refractive index between the light-emitting chip 4 and its peripheral part. This light transmitting member 5 is a material that is translucent to the light emitted from the light-emitting chip 4. The refractive index of the light transmitting member 5 is similar to that of the sapphire substrate forming the light-emitting chip 4. Further it is preferable that the refractive index of the material forming the light transmitting member 5 is lower than that of the material forming the reflecting member 3 or the material forming the surface other than the mounted portion 2a of the surface placing the light-emitting chip 4 in the base 2. For example, the usable materials of the light transmitting member 5 are phenyl group introduced silicon resin, silicon resin in which nanoparticles (diameter of a particle is less than 50 nm) of titania or zirconia is homogeneously dispersed, epoxy resin, organic-inorganic hybrid material having titania or zirconia in its structure, tin-fluorescent materials based glass with low melting point, and translucent polyimide resin. Further, gas can fill the inner space of the reflecting member 3 that is determined by the reflecting surface surrounding the light-emitting chip 4.

In the light emitting device of the present invention, the fluorescent layer 6 is formed to block the opening of the reflecting member 3 in the upper part of the light-emitting chip 4. The fluorescent layer 6 with fluorescent materials contained in the translucent member, and the fluorescent materials convert the wavelength of the light emitted from the light-emitting chip 4. The fluorescent layer 6 is placed to form a closed space by its bottom surface, the base 2 and the inner main surface of the reflecting member 3. As a result, the probability of the light absorbed in the fluorescent materials by reflecting the light repeatedly in the closed space is increased and the wavelength conversion efficiency is enhanced. Further, the whole or a portion of the closed space can be charged with the light transmitting member 5.

As for the translucent resin forming the fluorescent layer 6, material which is translucent to both the light emitted from the light-emitting chip 4 and the fluorescence emitted from the fluorescent materials, should be selected. For example, the usable materials are silicon resin, epoxy resin, urea resin, fluorine resin, sol-gel glass, organic-inorganic hybrid materials glass with low melting point, and translucent polyimide resin.

For example, the fluorescent layer 6 is formed to coat the light transmitting member 5. The fluorescent layer 6 can be formed by placing the fluorescent layer 6 containing fluorescent materials on the light transmitting member 5 after molding it in the desired shape in advance, or by kneading the fluorescent materials and the translucent member of unhardened liquid phase, and coating on the light transmitting member 5 in the liquid state to be a desired thickness by using the dispenser, and then hardening it in an oven.

Various materials are used as fluorescent materials contained in fluorescent layer 6, for example, La₂O₂S emitting fluorescence of red (about 580˜780 nm):Eu or Y₂O₂S:Eu, LiEuW₂O₈, Y₃Al₅O₁₂ emitting fluorescence of yellow (about 480˜700 nm):Ce, (BaMgAl)₁₀O₁₂ emitting fluorescence of green (about 450˜650 nm):Eu, Mn or ZnS:Cu, Al, SrGa₂S₄:Eu, BaMgAl₁₀O₁₂ emitting fluorescence of blue (about 420˜550 nm):Eu, (Sr, Ca, Ba, Mg)₁₀(PO₄)₆Cl₂:Eu.

Moreover, by placing the light emitting device 1 of the present invention on a jig composed of insulating substrates for placing the light emitting device which is employed as the light sources, and by providing the reflecting jig surrounding the light emitting device 1, the lighting apparatus of the present invention can be produced. As a result the probability that the light emitted from the light-emitting chip 4 excites fluorescent material is enhanced, and a lighting apparatus having a high light emitting efficiency is obtained.

The same material as the reflecting member 3 in the light emitting device 1 can be used in the reflection jig.

### EXAMPLE 1

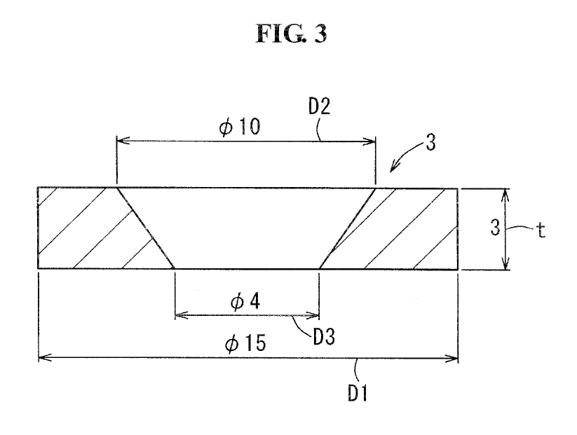

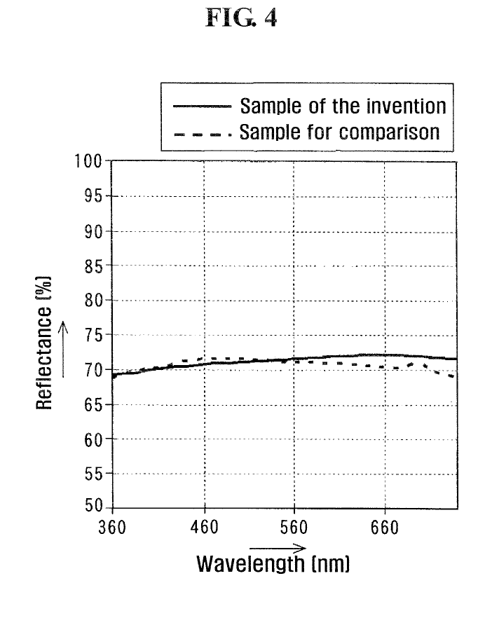

The light emitting device according to the present invention is examined as below. First, the reflecting member 3 was manufactured in the form shown in FIG. 3 by using alumina ceramics (specular reflectance relative to total reflectance is 10%) of which the inner main surface is diffusive reflecting surface, as the material of the reflecting member 3, and aluminum (A1050) (specular reflectance relative to total reflectance is 90%) with high purity of which the inner main surface is treated by mirror like finishing, as the material of the reflecting member for comparison (in FIG. 3 Φ represents diameter, and the unit is mm). That is, in the reflecting member 3, the external diameter (D1) is 15 mm, the inside diameter (D2) of the fluorescent layer side is 10 mm, the inside diameter (D3) of the light-emitting chip sides is 4 mm, and thickness (t) is 3 mm. Further, the total reflectance of both was set to be approximately 70%. FIG. 4 shows the total reflectance of the reflecting member 3 of the light emitting device in the present invention and the reflecting member 3 for comparison.

Next, the light emitting device (the light emitting device using the reflecting member 3 according to the present invention is sample 1, and the light emitting device using the reflecting member 3 for comparison is sample 2) shown in FIG. 1 was manufactured by using the two kinds of reflecting members 3. Also, as the light-emitting chip 4, the flip chip type of gallium nitride based, peak wavelength 400 nm, half-value breadth 20 nm, each side of square 0.35 mm, rated current 0.02 A and light output 10 mW was used, and as the base 2, alumina ceramics was used, and as the light transmitting member 5 silicon resin was used. As the fluorescent material contained in the fluorescent layer 6, red; La₂O₂S:Eu, green; (BaMgAl)₁₀O₁₂:Eu, Mn, blue; (Sr, Ca, Ba, Mg)₁₀(PO₄)₆C₂:Eu was used, which was molded in tape shape with the thickness of 1 mm, and hardened for 30 minutes at 150° C. in an oven after mixing 1 weight silicon resin with 1 weight of fluorescent material.

Total light flux value (lumen value) of the light emitting device 1 was measured and compared by making 0.02 A of electric current flow on the light-emitting chip 4 after sample 1, 2 were manufactured (Table 1). Also, for measuring total light flux, the total light flux measurement system SMLS1020 attached with integrating sphere of Labsphere was used.

TABLE 11

| Sample No. | 1 | 2 |
|---|---|---|
| the ratio of the total light flux (the value obtained in | 2.1 | 1 |
| sample 2 is set as 1) | | |

From the result shown in Table 1, it was proved that the total light flux value of sample 1 according to the present invention is 2.1 times higher than that of sample 2 as a comparative example. By this, it is thought that by using the reflecting member 3 of which the inner main surface is composed of diffusive reflecting material, the wavelength conversion efficiency of the fluorescent material in the fluorescent layer 6 can be enhanced.

### EXAMPLE 2

The form of the reflecting member 3 shown in FIG. 3, was manufactured by using alumina ceramics as the material of the reflecting member 3. Also, as in example 1, the total reflectance of the inner main surface was set to be approximately 70%.

Also, as the light-emitting chip 4, the flip chip type of gallium nitride based, peak wavelength 400 nm, half-value breadth 20 nm, each side of square 0.35 mm, rated current 0.02 A and light output 10 mW was used.

As the base 2, alumina ceramics was used, and as the light transmitting member 5, silicon resin was used.

As the fluorescent materials, red; La₂O₂S:Eu, green; (BaMgAl)₁₀O₁₂:Eu, Mn, blue; (Sr, Ca, Ba, Mg)₁₀(PO₄)₆C₂:Eu was used. And total four kinds of light emitting devices were manufactured: mixing silicon resin 1 weight with fluorescent material 1 weight as sample 3, mixing silicon resin 1.2 weight with fluorescent material 1 weight as sample 4, mixing silicon resin 1.5 weight with fluorescent material 1 weight as sample 5, and mixing silicon resin 2 weight with fluorescent material 1 weight as sample 6. Further, each fluorescent layer 6 was mounted on the light emitting device 1 after molding them in thick-film shapes with the thickness of 1 mm, and hardening for 30 minutes at 150° C. in an oven, and then being formed into a tape-type.

The total light flux value (lumen value) of the light emitting device 1 was respectively measured and compared by making 0.02 A of electric current flow on the light-emitting chip 4, after manufacturing the light emitting device 4 mounting the above four kinds of fluorescent layers (Table 2).

Also, to roughly estimate the quantity of light emitted to the outside out of the light emitted from the light-emitting chip 4, a ratio of the peak wavelength strength was calculated in the light-emitting chip 4 before and after mounting the fluorescent layer 6 respectively. Further, for measuring the total light flux, total light flux measurement system SMLS1020 attached with integrating sphere of Labsphere was used.

TABLE 2

| Sample No. | 3 | 4 | 5 | 6 |
|---|---|---|---|---|
| weight of fluorescent material | 1 | 1 | 1 | 1 |
| weight of silicon resin | 1 | 1.2 | 1.5 | 2 |
| the ratio between the quantity of light | 3.2% | 5.3% | 19.2% | 21.2% |
| emitted from the light emitting device | | | | |
| and the quantity of light emitted to | | | | |
| the outside | | | | |
| the ratio of total light flux (the value | 2.1 | 1.9 | 1.2 | 1.05 |
| obtained in sample 2 is set as 1) | | | | |

From the result in Table 2, in the light emitting device 1 using sample 3 as the fluorescent layer 6, 3.2% of the light from the light-emitting chip 4 was emitted outside. Further in the light emitting device 1 using sample 4 as the fluorescent layer 6, 5.3% of the light from the light-emitting chip 4 was emitted outside. Further in the light emitting device 1 using sample 5 as the fluorescent layer 6, 19.3% of the light from the light-emitting chip 4 was emitted outside. Further in the light emitting device 1 using sample 6 as the fluorescent layer 6, 21.2% of the light from the light-emitting chip 4 was emitted outside.

Moreover, the light emitting device 1 using sample 3 as a fluorescent layer 6 has the highest level of the total light flux, and the level of the total light flux in the light emitting device 1 using sample 4 as the fluorescent layer 6 and that of the total light flux in the light emitting device 1 using sample 3 as the fluorescent layer 6 were approximately the same. Further, the value of the total light flux in the light emitting device 1 using sample 5 as the fluorescent layer 6 was slightly lower but it was higher than that of the total light flux in the device 1 using sample 2 for comparison of example 1. Further, the value of the total light flux in the light emitting device 1 using sample 6 as the fluorescent layer 6 and that of in the device 1 using sample 2 for comparison of example 1 were approximately the same.

Therefore from the results above, it is preferable that the quantity of light from the light-emitting chip 4 in the closed space formed by the reflecting member 3 and the fluorescent layer 6, released to the outside is less than 20% of the quantity of light emitted from the light-emitting chip 4. And it is more preferable that the quantity of the light from the light-emitting chip 4 in the closed space formed by the reflecting member 3 and the fluorescent layer 6, released to the outside is less than 5% of the quantity of light emitted from the light-emitting chip 4.

It is to be understood that the application of the invention is not limited to the specific embodiments described heretofore, and that various modifications and variations of the invention are possible within the spirit and scope of the invention.

The light emitting device according to the present invention is provided with a reflecting surface which surrounds the region between the light-emitting chip and the fluorescent layer, and scatters and reflects the first light emitted from the light-emitting chip and the first light reflected by the fluorescent layer. Therefore the light emitted from the light-emitting chip does not excite the fluorescent materials and is reflected by the surface of the fluorescent materials to be returned to the downside. Because the returned light produces a scattered reflection on the diffusive reflecting surface of the inner main surface in the reflecting member and proceeds to the upper side, the light can be effectively absorbed in the fluorescent materials in the fluorescent layer. As a result, the light emitting device with high light emitting efficiency can be obtained by improving the wavelength conversion efficiency.

That is, if the inner main surface of the reflecting member is composed of a flat surface similar to the conventional art, the light which is reflected by fluorescent material and returned to the downside is specularly reflected and proceeds in the opposite direction to the fluorescent layer and then two or more reflections are needed, till the light collides with the fluorescent layer again. As a result, a reflection loss is piled and the intensity of the light emitted from the light-emitting chip is decreased. With respect to a decrease in the amount of the light that collide again with the fluorescent layer, the light emitting device according to the present invention has the inner main surface of the reflecting member as a diffusive reflecting surface so that the returned light is reflected only once by the inner main surface of the reflecting member and proceeds again to the fluorescent layer. Consequently, the reflection loss is decreased and the light emitting device according to the present invention can increase the amount of the light absorbed in the fluorescent materials in the fluorescent layer.

Therefore the probability that the light emitted from the light-emitting chip excites the fluorescent materials in the fluorescent layer, can be highly improved, thereby enhancing the light emitting efficiency of the light emitting device.

Further, the activating agent in the fluorescent materials is excited by the light emitted from the light-emitting chip and eased after a certain time, and then the fluorescent materials emits a wavelength converted light, and the life-span of light emitting, from exciting to easing, is about 1 is to 1 ms. And when the excited light is collided repeatedly during from exciting to easing, it is thought that the fluorescent material absorbs the light continuously until the amount of the activating agent is saturated. Moreover, in the light emitting device according to the present invention with a reflecting member in which the inner main surface is a diffusive reflecting surface, the required time during which the light emitted from the light-emitting chip is reflected by the fluorescent layer, returned effectively to the upper side from the diffusive reflecting surface, and collides with the fluorescent layer again, in the closed space determined by the reflecting member, the fluorescent layer, and the base, can be made shorter than the life span of the fluorescent material. And since the amount of activating agent contained in the fluorescent materials is sufficiently larger than that of the photon emitted from the light-emitting chip, the light emitted from the light-emitting chip can be effectively absorbed in the fluorescent material in the fluorescent layer, by multiply reflecting the light emitted from the light-emitting chip in the closed space determined by the reflecting member, the fluorescent layer, and the base and colliding multiple times with the fluorescent layer.

Therefore the light can collide multiple times with the fluorescent layer by multiply reflecting the light emitted from the light-emitting chip in the closed space determined by the reflecting member, fluorescent layer, and the base. As a result, the probability that the light emitted from the light-emitting chip excites the fluorescent material in the fluorescent layer, can be highly improved, thereby enhancing the light emitting efficiency of the light emitting device.

1. A light emitting device comprising:
a light-emitting chip which emits a first light having a peak wavelength within a first wavelength range;
a fluorescent layer which is arranged above the light-emitting chip and emits a second light having a peak wavelength within a second wavelength range which is larger than the first wavelength range corresponding to the first light; and
a reflecting surface which surrounds the region between the light-emitting chip and the fluorescent layer and scatters and reflects the first light emitted from the light-emitting chip and the first light reflected by the fluorescent layer.

2. The light-emitting device according to claim 1, wherein the reflecting surface is roughened, and a space which is determined by the reflecting surface surrounding the light-emitting chip, is filled with light transmitting resin.

3. The light-emitting device according to claim 1, wherein the reflecting surface is roughened, and a space which is determined by the reflecting surface surrounding the light-emitting chip, is filled with gas.

4. The light-emitting device according to claim 1, wherein the reflecting surface is formed with ceramic particles coating on the surface of a reflecting member surrounding the light-emitting chip.

5. The light-emitting device according to claim 1, wherein a plurality of minute holes are formed on the reflecting surface.

6. The light-emitting device according to claim 1, wherein a plurality of minute protrusions are formed on the reflecting surface.
